(19) United States
(12) Patent Application Publication
(10) Pub. No.: US 2026/0278349 A1
(43) Pub. Date: Sep. 17, 2026

(54) Prompt Support and Query Intervention

(71) Applicant: MICROSOFT TECHNOLOGY LICENSING, LLC, Redmond, WA (US)

(72) Inventors: Bahareh SARRAFZADEH, Seattle, WA (US); Nirupama CHANDRASEKARAN, Kirkland, WA (US); Sujay Kumar JAUHAR, Kirkland, WA (US); Subhojit SOM, Bellevue, WA (US); Longqi YANG, Redmond, WA (US); Nagendran RANGAN, Redmond, WA (US); Rupak SARKAR, College Park, MD (US)

(21) Appl. No.: 19/222,934

(22) Filed: May 29, 2025

Related U.S. Application Data
(60) Provisional application No. 63/772,433, filed on Mar. 14, 2025.

(51) Int. Cl. G06N 3/0475; G06N 3/096

(52) U.S. Cl. CPC G06N 3/0475; G06N 3/096

(57) ABSTRACT

A user's interaction with a first AI model is monitored, the interaction including a prompt for input to the first AI model. An indication of user dissatisfaction with a response to the prompt is detected. A second AI model is caused to rewrite the prompt based on a conversational history of the user's interaction with the first AI model. The second AI model is trained using past conversational histories with the first AI model and rewritten prompts for the first AI model.

### PRIORITY APPLICATION

This application claims priority to Provisional U.S. Patent Application No. 63/772,433, filed on Mar. 14, 2025, entitled “PROMPT SUPPORT AND QUERY INTERVENTION”, the entire contents of which are incorporated herein by reference.

### BACKGROUND

Computing systems generally provide interactive and collaborative environments that facilitate communication with various functions including interfaces to various language models. For newer users who are unfamiliar with prompting language models, the learning curve might discourage the use of language models. Poor prompting can result in a poor user experience, which can be detrimental to the user's ability to improve their interactions and receive effective and accurate outputs. A poor initial experience can also cause users to discontinue use because they do not see sufficient value from their experiences/interactions. When such environments do not optimize interactions with users, user dissatisfaction, production loss, and inefficiencies can result. It is with respect to these considerations and others that the disclosure made herein is presented.

### SUMMARY

In various embodiments, techniques are disclosed for query intervention techniques based on conversational logs between users and systems that provide artificial intelligence (AI) based services. The techniques can improve user retention by addressing challenges faced, for example, by new users who are unfamiliar with prompting and may find the learning curve difficult, as well as helping more seasoned users accomplish their goals more efficiently. The disclosed techniques allow for improved user experiences and improvements in conversational AI systems. The disclosure includes systems and techniques for:
interactively rendering clarifying questions to the user in order to clarify unclear intent, then respond once the model has sufficient information to do so
providing users with a dynamically generated prompt template with placeholders for the user to fill in, in order to guide the user in formulating a query
implicitly rewriting user queries to better match the capabilities of the model using taxonomized aspects and assumptions, and provide the user with the rewritten query to confirm or edit
learning user preferences (both at the individual and cohort levels) over time so that fewer (low confidence) assumptions about a user are made and respond in a tailored manner
learning from taxonomized rewrite patterns in order to improve the intent understanding and capabilities of the underlying model to respond to user queries effectively. (e.g., through prompt augmentation or fine-tuning).

The examples described herein are provided within the context of collaborative environments but can be applied in any AI-based environment. Additionally, while many of the illustrated examples use large language models (LLMs), it should be noted that other models can be utilized without limiting the scope of the disclosure.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

### BRIEF DESCRIPTION OF THE DRAWINGS

FIGS. 1A and 1B illustrate example systems showing aspects of an AI environment for the embodiments disclosed herein.

FIG. 2 illustrates example process, according to embodiments disclosed herein.

FIG. 3 illustrates an example according to one embodiment disclosed herein.

FIG. 4 illustrates an example according to one embodiment disclosed herein.

FIG. 5 illustrates an example according to one embodiment disclosed herein.

FIG. 6 illustrates an example according to one embodiment disclosed herein.

FIG. 7 illustrates an example according to one embodiment disclosed herein.

FIG. 8 is an example functional diagram illustrating aspects of prompt generation for the embodiments disclosed herein;

FIG. 9 is a computing system diagram showing aspects of an illustrative operating environment for the technologies disclosed herein;

FIG. 10 is a computing system diagram showing aspects of an illustrative operating environment for the technologies disclosed herein;

FIG. 11 is a computing device diagram showing aspects of the configuration and operation of a device that can implement aspects of the disclosed technologies, according to one embodiment disclosed herein.

FIG. 12 is a computing system diagram showing aspects of an illustrative operating environment for the technologies disclosed herein;

FIG. 13 illustrates aspects of a routine, according to one embodiment disclosed herein;

FIG. 14 illustrates aspects of a routine, according to one embodiment disclosed herein;

FIG. 15 is a computing system diagram showing aspects of an illustrative operating environment for the technologies disclosed herein;

FIG. 16 is a computing device diagram showing aspects of the configuration and operation of a device that can implement aspects of the disclosed technologies, according to one embodiment disclosed herein.

### DETAILED DESCRIPTION

The following Detailed Description describes various techniques for query intervention strategies for systems that use AI. Technical benefits other than those specifically described herein might also be realized through implementations of the disclosed technologies.

There are a number of reasons why users may not be satisfied with their AI experience. For example, the responses are not fast enough, the user does not trust AI responses because of potential LLM hallucinations, or the user has use cases that are not well suited for AI. Many new users have suboptimal experiences because they are not proficient at prompting AI systems. Some users are accustomed to search engine (SE) style queries and do not provide sufficient context. Search engines are optimized for key-word style querying, while LLMs are optimized for natural language interactions. Some users do not have a clear idea of what can/cannot be done with an AI system. Existing tools for designing better prompts are primarily geared towards professionals and natural language processing (NLP) practitioners. Meanwhile, most users of commercial chatbots are laypeople, who may not have an intuitive understanding of how to write effective prompts.

The disclosed techniques provide systems that are more proficient at understanding the information needs of users and aligning user goals with model capabilities in AI-based platforms. In various embodiments, patterns of querying that are correlated with user satisfaction are taxonomized, and the assumptions that the models are making in interpreting user queries are determined. The disclosed techniques enable systems to interactively adapt to user intents and goals. The disclosed techniques can also help more experienced users to reach a successful outcome more efficiently, and with fewer iterations. With the development of new models (particularly LLMs), prompting patterns can change; older prompts may not work as well, and new capabilities may not be reflected in older prompts. Users (both novice and expert) are not expected to constantly adapt their prompting behavior.

In some embodiments, the techniques are developed from real user conversations. With more powerful LLMs, the techniques can also be developed from fully simulated multi-agent synthesized AI conversations.

In an embodiment, an LLM is used to analyze previous user/system conversations at scale, and rewrite patterns are taxonomized that can improve the quality of queries and subsequent interactions. This taxonomization can be derived from conversations that went poorly (e.g., by asking the LLM to list aspects of the conversation that can be improved), from conversations that went well (by asking the LLM to list aspects of the conversations that helped yield a good response, as further detailed below), as well as contrasting between conversations that had similar intents but resulted in divergent satisfaction from the users' perspective.

In an embodiment, LLMs are leveraged to explicitly detail the assumptions that the system is likely making when intervening with a user query or responding to a user query, and using these signals in order to prioritize and rank rewrite/response operations. The disclosed embodiments can allow for improved system responses when rewriting previously issued user queries that resulted in unsatisfactory responses. The disclosed embodiments can further improve transparency and trust with users by providing users with a clearer picture of how the system is interpreting their queries and what assumptions are being made on the user's behalf in order to respond.

In an embodiment, the system determines whether to rewrite a query and the degree to which the query should be rewritten. The system further identifies the aspects in which the query needs to improve or is already effective. If a rewrite is required, the objective for the rewrite is to keep the rewrite as contextual as possible and maintain the user's intent. Additional information to be obtained include assumptions, saliency, and plausibility.

In an embodiment, two LLMs are employed, one with which the user is having a conversation (which can be referred to as the chatbot LLM or chatbot), and the second which is used to rewrite prompts, (which can be referred to as the rewriter LLM or the rewriter). During the process of performing a prompt rewrite, the rewriter LLM is asked to generate additional insights. The insights can include the degree of modification required, the aspects of improvement (such as clarity, or specificity), and the assumptions, if any, that the model needs to make in order to construct an effective prompt.

In one embodiment, when a user prompt indicates dissatisfaction, an assumption can be made that the model response causing the dissatisfaction was caused by a prompt that inadequately expressed the information needs of the user. For example, patterns of user satisfaction can be generated from thumb feedback (a thumbs up signaling positive feedback and a thumbs down signaling negative feedback) and summarizing these patterns into a rubric and a score. In some embodiments, dissatisfaction can be determined based on a threshold, which can be a numerical value, a range of values, an output of a function configured to detect dissatisfaction, and the like. In an embodiment, dissatisfaction can be determined by an AI model that has been trained to detect dissatisfaction. Any of these examples may be referred to as a dissatisfaction threshold.

In some embodiments, prompt intervention can be performed in a retro-active manner, where the conversation has already happened, and what the impact of the re-write would have been in context is investigated. In a real-world setting, the disclosed embodiments implement proactive techniques, where the system performs rewrites, asks clarifying questions, etc. before the user has expressed dissatisfaction. In other words, the system anticipates when a prompt is unlikely to result in a satisfactory response, and performs interventions accordingly. Additionally, the disclosed embodiments facilitate continual learning and continually improvement of the system, rewriting the taxonomy and intervention behavior and the like, based on in-situ feedback from real-world usage.

In one embodiment, in response to a user turn that indicates dissatisfaction, a rewriter LLM is used to reformulate the preceding user turn, and measure how a chatbot LLM responds to this rewritten prompt. For example, if a prompt is vague (e.g., does not include any specifics of how to implement a request, such as the desired format of input or output, etc.), the chatbot may output a response that results in a dissatisfied response from the user. The vague prompt is then selected as a candidate for rewrite.

In some embodiments, a quality measure is used to represent how well an LLM response satisfies the intent of a user's prompt. In one embodiment, a corpus of real-world user-LLM conversations is analyzed. Conversation turns are classified into domains and intents, where domains cover topical categories and intents refer to the user's conversational goals, and domains classify a conversational turn into topical categories and intents classify a conversational turn based on the nature of the user's goal.

In one embodiment, the rewriter LLM processes an input user prompt along with the conversational history with the chatbot LLM, reasons about the aspects in which the query needs to improve, as well as the assumptions needed to form a rewrite before proposing a rewrite. In an example, in order to generate a more specific prompt, the model writes the prompt to add information required in the response, data to be incorporated in the response, and the format of the response. In addition to obtaining an improved response, the rewritten prompt provides the user with an example of what constitutes a good prompt. The quality of the response to this rewritten prompt can be comparatively measured against the original, using either an LLM or other evaluative process.

Given the cost of fine-tuning LLMs and lack of relevant prompt rewriting data, a prompting strategy can be implemented to steer models. Depending on a cost vs. benefit analysis, both augmentation and fine-tuning are options for prompt intervention. In one embodiment, two instruction categories can be implemented: the first for directly instructing the model performing the rewrite, and the second for generating additional insights that serve as a chain-of-thought for improving analysis.

Given a candidate turn, models are instructed to reason about the degree with which it needs a rewrite on a 3-point scale in one embodiment: NO MOD indicating that the rewriter LLM has judged the prompt to be adequate, SOME MOD, and HEAVY MOD. This allows for the pipeline to be robust for cases that would otherwise not benefit from prompt rewriting. For the cases identified as SOME MOD or HEAVY MOD, models are instructed to generate an improved rewritten prompt while maintaining user intent. Using this rewritten prompt, a new candidate response is generated. In some cases, the proposed rewrites can contain rephrasing of a user prompt while omitting certain details from the original response. A set of proposed rewrites can be generated from which one is selected. Maintaining the conversational history, the selected rewrite is used to obtain a modified response. The modified response can be comparatively evaluated against the original response. The comparative evaluation uses objective metrics such as relevance and contextuality.

In addition to a reformulated prompt, models can be instructed to reason in a fine-grained manner in order to generate additional insights about the rewriting operation. One category of insights includes open-ended free-text categories such as clarity, specificity, tone, etc. that models are instructed to list as they perform a rewrite. These aspects can be used to determine along what dimensions sub-optimal user queries fall short, as well as gain insights into the ways LLMs perform rewriting operations. In some embodiments, models can be instructed to generate categories in which the user prompt can be improved. The insights can be used to help the LLM reason better about how to perform the re-write, and also to develop trust in the user by being transparent about the rewrite process.

Another category of insights includes assumptions that the model needs to make in order to effectively rewrite a prompt. This can be relevant in cases when the user input is underspecified, or the historical conversation context lacks sufficient grounding information. In such cases the model is instructed to list plausible assumptions about the user's information goals. Assumptions can be useful for determining how models reason about user needs, as well as measuring the impact that these assumptions have on LLM response quality. When the rewriter is tasked with proposing a rewrite, the information present in the provided context may not be sufficient to construct an effective query. In those cases, an LLM acting as a rewriter can make plausible inferences about the user's information goals.

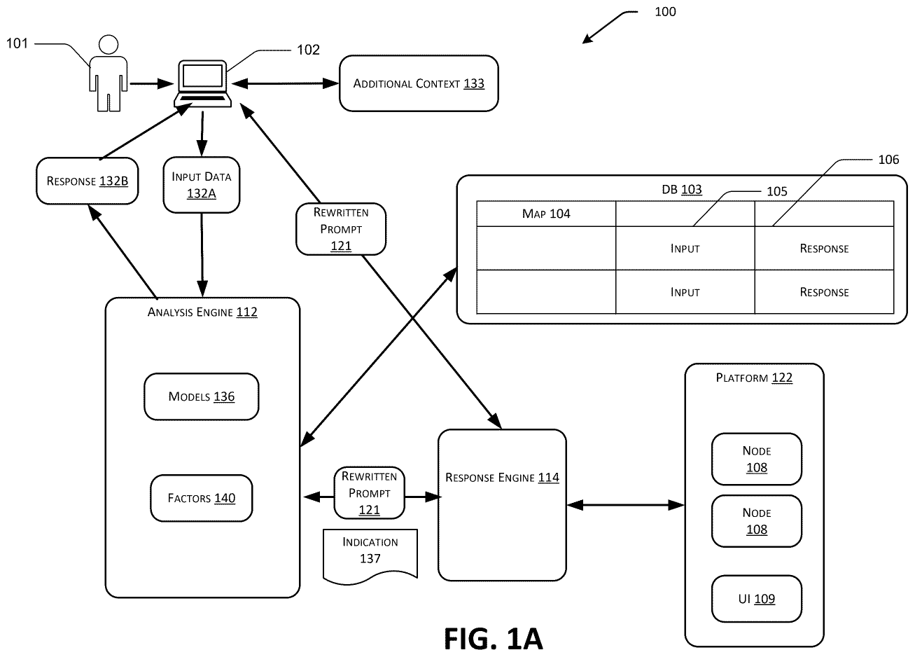

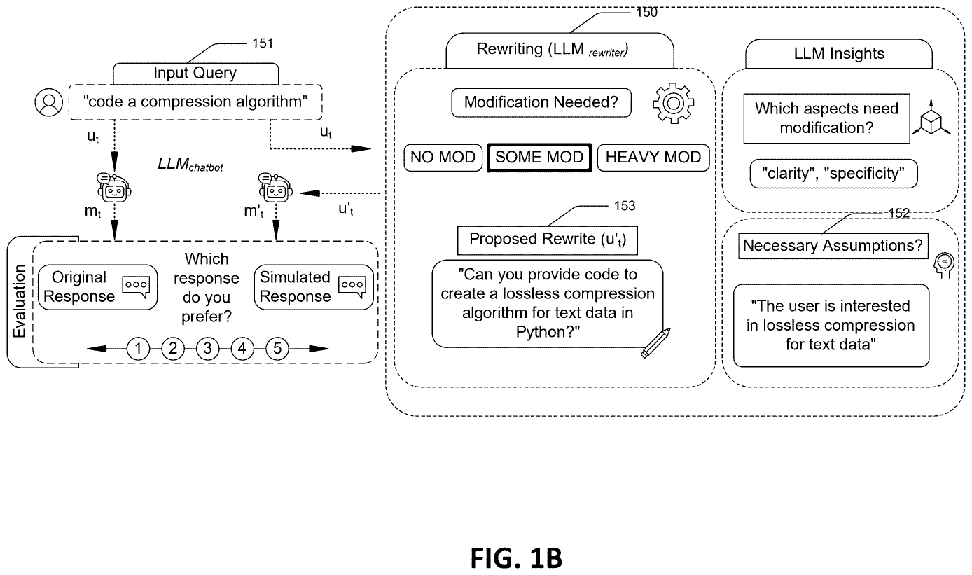

FIG. 1B illustrates an example of prompt rewriting and evaluation. The rewriter 150 processes an input user prompt 151 along with the conversational history with the chatbot, and reasons about the aspects in which the query needs to improve, as well as the assumptions 152 needed to make a rewrite before proposing a rewrite 153. The quality of the response to this rewritten prompt is comparatively measured against the original, using either an LLM or other process.

The following are example prompts used for rewriting user prompts and for comparing model responses.

### Rewriting User Prompts

### Prompt:

Goal: Given a user's query and their conversational history with an AI Chatbot, your task is to identify the aspects in which the query can be improved or if it's already optimal, identify the aspects in which it is already effective. To do so, first analyze the query for aspects of improvement or describe aspects that are already effective. Then, propose a list of one or more possible rewrites that communicates the user's needs and goals more effectively as an input to an AI Chatbot while keeping the user intent intact. Be careful not to change the goal or the intent of the user when you propose a rewrite keeping in mind the Conversational History. For each rewrite, if you have to add any new information that is not present in the Conversational History to make the query better, list the assumptions you need to make.
Task: Given a user Query, your task is to output the following:
First, output whether or not the Query needs modification for eliciting an effective response from an AI Chatbot. If it's a good query and doesn't need any modification at all, output NO MOD. If it requires some modification, output SOME MOD. If the Query requires it to be heavily rewritten, output HEAVY MOD.
If you chose NO MOD, output the aspects of the query that makes it an effective query in a markdown table in the following format:
<table format>
If the query needs any rewrite (that is, if you answered SOME MOD or HEAVY MOD in the previous question), output the aspects of improvement in a markdown table in the format below:
<table format>
DO NOT answer the input Query, your job is only to evaluate how well it expresses the user's information need from a Chatbot.
Conversational History: query_context
Query: target_query

### Rewrite Output Format

If you propose a list of rewrites, then for each rewritten query, list the following information:
Rewrite: The Rewritten Query. Make sure to include ALL relevant information from the original Query and the Conversational History
Information Added: Whether information beyond what's present in the Query or the Conversational History needs to be added in the rewrite. Reply YES or NO
Assumptions: If there's additional information needed to be added to the user's query for it to be effective, then those are assumptions about the user's goals that need to be made. If you answered YES in the previous step, list the assumptions along with how salient they are for the rewrite, and how plausible they are for the user to believe in from a scale of HIGH, MID and LOW in a markdown table in the format below:
   |assumption|salience|plausibility|
   |<assumption text>|<HIGH, MID or LOW>|<HIGH, MID or LOW>|\\
Note:
The conversational history may or may not be present, and it provides you with some context on the user query you need to analyze. If the context is about a different task or topic, discard it.
Order the rewrites from the most likely to the least.
Output using the template outlined below:
<START OF OUTPUT TEMPLATE>:
. . . \\
<END OF OUTPUT TEMPLATE>
Conversational History: query_context
Query: target\_query\
Based on the Query and the Conversational History, fill out the OUTPUT TEMPLATE in order to structurally analyze the user Query in context without trying to answer the query.

### Evaluation Prompt

### Prompt:

### Context

You will be shown conversations of a user with a chatbot providing users with information about their queries in their preferred language based on its knowledge, common sense and natural language understanding. The chatbot task is to infer the user's intent and context from the conversation and provide the most relevant and useful information to the user.

### Instructions

You are given a conversational history between a user and the chatbot, and two possible endings to that conversation. From the conversational history, you need to understand the goals of the user in the conversation and determine which of the two endings better satisfy the information needs of the user.

### Scoring Guidelines

Make a judgment on which of the two endings offers a richer user experience on a 5-point Likert scale, where:
1 indicates that the model response in Ending 1 is much better than Ending 2
2 indicates that the model response in Ending 1 is somewhat better than Ending 2
3 indicates that the model response in Ending 1 and Ending 2 are equally good/bad
4 indicates that the model response in Ending 2 is somewhat better than Ending 1
5 indicates that the model response in Ending 2 is much better than Ending 1

### General Evaluation Guidelines

The response must be contextual, taking all conversational context into account while responding to user.
The response should be directly relevant to the user's query and be essential to satisfy their information needs.

### Intent Preservation Annotation Instruction

### Instruction:

Question 1: In this task, you will be provided the conversational history between the user and the chatbot. This time, it will be revealed which ending is the Original Ending and which is the Rewritten one.
Your task is to answer two questions about the original vs rewritten prompt (without considering the model responses) on a 3-point Likert scale.
Question 1: To what extent is the intent of the user as expressed in the original ending and the conversational history carried over in the rewrite? Return a score from 1 to 3, where
1 indicates that the rewritten prompt does not at all maintain the same intent as the original prompt.
2 indicates that the rewritten prompt somewhat maintains the overall intent of the original prompt.
3 indicates that the rewritten prompt maintains the exact same intent as the original prompt.

### Assumption Plausibility Annotation Instruction

### Instruction:

Question 2: If the rewrite does change the intent (you chose 1 or 2 in the previous step), are there any assumptions made by the model in constructing the rewrite? If so, assign a score of 1-3 that denotes how plausible the assumptions are in satisfying the information goals of the user, given the intent expressed in the conversational history and the original prompt.
Assign a score from 1-3 where:
1 indicates that the assumptions are not plausible at all, given the intent described by the user in the available data.
2 indicates that the assumptions are somewhat plausible given the intent described by the user in the available data.
3 indicates that the assumptions are very plausible given the intent described by the user in the available data.
If there are no assumptions made by the model, leave this section blank.

The disclosed technologies can be implemented to provide systems that are configured to:
interactively render clarifying questions to the user in order to clarify unclear intent, then respond once the model has sufficient information to do so
provide users with a dynamically generated prompt template with placeholders for the user to fill in, in order to guide the user in formulating a query
implicitly rewrite user queries to better match the capabilities of the model using taxonomized aspects and assumptions, and provide the user with the rewritten query to confirm or edit
learn user preferences over time so that fewer (low confidence) assumptions about a user are made and respond in a tailored manner
learn from taxonomized rewrite patterns in order to improve the intent understanding capabilities of the underlying model (e.g., through prompt augmentation or fine-tuning).
improve synthetic data generation from LLM systems.

The disclosed technologies can improve user interaction with a computing device by detecting user dissatisfaction with an LLM response and improving the prompt and response, thus providing timely and relevant intervention and thus providing more efficient use of computing resources. Among many benefits provided by the technologies described herein, a user's interaction with a device may be improved, which may reduce the number of erroneous inputs and outputs, reduce the consumption of processing resources, and mitigate the waste of network resources. Other technical effects other than those mentioned herein can also be realized from implementations of the technologies disclosed herein.

As used herein, “AI” refers to the use of computing systems to perform intelligent tasks such as language processing, analysis, and problem solving. An example of a model utilizing AI is a Large Language Model (LLM). Although many examples in the present disclosure are illustrated using LLMs, it should be understood that the disclosure can be implemented using other models. Additionally, although many examples in the present disclosure are illustrated using AI-based systems, it should be noted that the disclosed embodiments can be implemented in systems that do not interact with or incorporate AI-based systems and technologies.

The disclosed model can support various applications across various domains in artificial intelligence, such as natural language processing (NLP) and human-computer interaction (HCI). By incorporating the disclosed model, AI systems can achieve a higher level of service quality, leading to more effective interactions. The disclosed model provides a structured and efficient approach to prompt rewriting that improves token usage.

Regarding the figures (which might be referred to herein as a “FIG.” or “FIGS.”), additional details are provided regarding an improved prompt interface disclosed herein with reference to the accompanying drawings. The figures show, by way of illustration, specific configurations or examples. Like numerals represent like or similar elements throughout the FIGS. In the FIGS., the left-most digit(s) of a reference number generally identifies the figure in which the reference number first appears. References made to individual items of a plurality of items can use a reference number with another number included within a parenthetical (and/or a letter without a parenthetical) to refer to each individual item. Generic references to the items might use the specific reference number without the sequence of letters. The drawings are not drawn to scale.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings. Furthermore, the claimed subject matter is not limited to implementations that solve any or all disadvantages noted in any part of this disclosure.

It should be appreciated that various aspects of the subject matter described briefly above and in further detail below can be implemented as a hardware device, a computer-implemented method, a computer-controlled apparatus or device, a computing system, or an article of manufacture, such as a computer storage medium. While the subject matter described herein is presented in the general context of program modules that execute on one or more computing devices, those skilled in the art will recognize that other implementations can be performed in combination with other types of program modules. Generally, program modules include routines, programs, components, data structures, and other types of structures that perform particular tasks or implement particular abstract data types.

Those skilled in the art will also appreciate that aspects of the subject matter described herein can be practiced on or in conjunction with other computer system configurations beyond those specifically described herein, including multiprocessor systems, microprocessor-based or programmable consumer electronics, AR, VR, and MR devices, video game devices, handheld computers, smartphones, smart televisions, self-driving vehicles, smart watches, e-readers, tablet computing devices, special-purpose hardware devices, network appliances, and the others.

With reference to FIG. 1A, a multi-platform framework 100 is configured to receive input data 132A and optionally additional context 133 from a user 101 using device 102. The multi-platform framework 100 is configured to execute an analysis engine 112 that can include one or more models 136 and factors 140.

A database 103 includes mapping data 104 for mapping inputs 105 and responses 106. The database 103 can include one or more tables or other data structures. A response engine 114 can generate a response to the user 101 and can further provide inputs to a platform 122 with nodes 108 and UI 109.

In an embodiment, a user interface (UI) is rendered on device communicatively 102. The UI is configured for interacting with user 101 and providing access to a first artificial intelligence (AI) model of models 136. A second AI model of the models 136 monitors the user's interaction with the first AI model. In an embodiment, the interaction includes a prompt for input to the first AI model. In an embodiment, the second AI model is trained to evaluate and rewrite input prompts using past user conversational histories with the first AI model and past rewritten prompts. An indication 137 of user dissatisfaction with a response to the prompt from the first AI model is detected. In response to detecting the indication, the second AI model rewrites the prompt based on a conversational context of the user's interaction with the first AI model. In an embodiment, the rewritten prompt 121 is generated dynamically based on an assumption specific to the user 101. The second AI model inputs the rewritten prompt 121 to the first AI model. The rewritten prompt 121 is rendered on the UI along with a response 132B to the rewritten prompt from the first AI model.

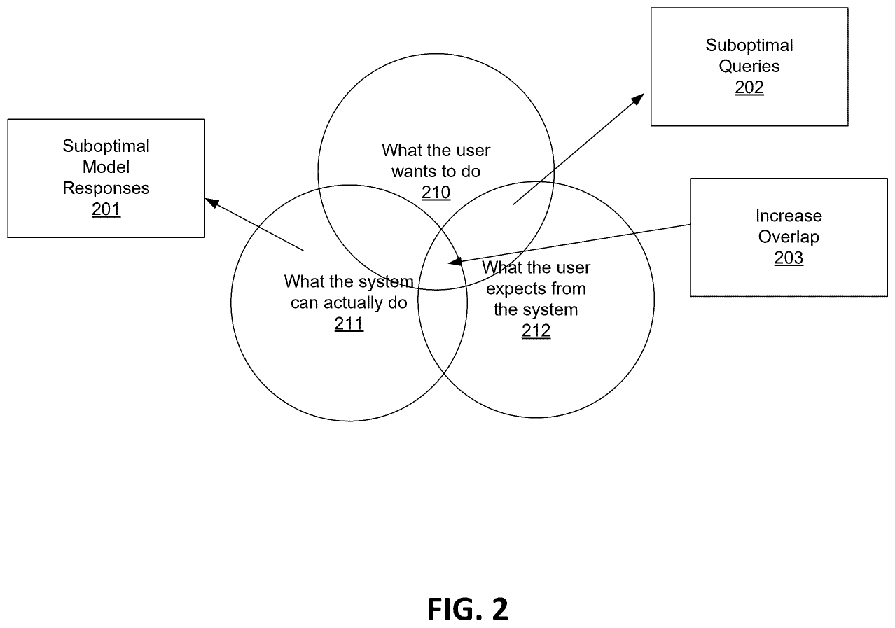

Referring to FIG. 2, suboptimal queries 202 are queries where the user may assume that the chatbot can answer a request that is not possible (where what the user wants to do 210 and what the system can actually do 211 do not intersect), or queries that do not have sufficient information (underspecified), have too many details (overspecified), or does not contain clear instructions. A suboptimal model response 201 is one where the model does not have an answer, but nevertheless attempts to respond without asking for more information. An objective of the disclosed embodiments is to increase the overlap 203 of all three circles.

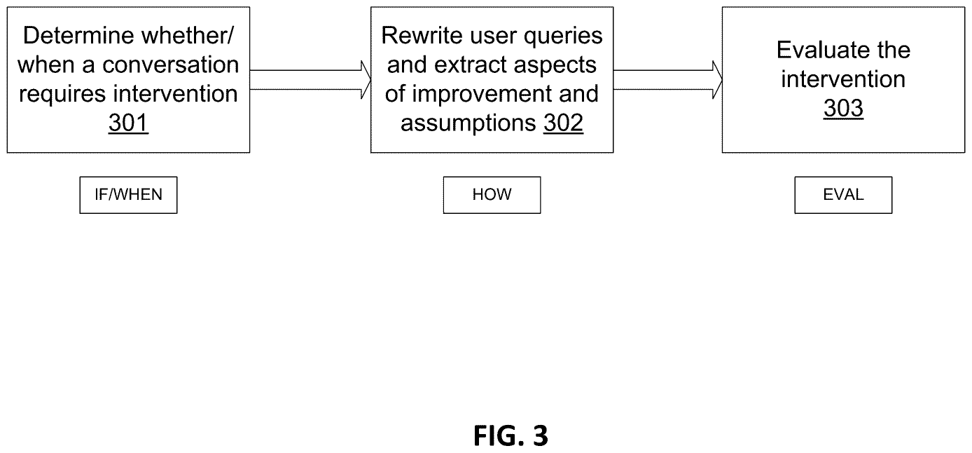

FIG. 3 illustrates a three-step process where in the first step 301, it is determined if and when a conversation requires intervention. In the second step 302, rewrites are proposed considering the aspects of the query that need to change, as well as the assumptions about the users' goals that the model needs to make. In the third step 303, the intervention is evaluated.

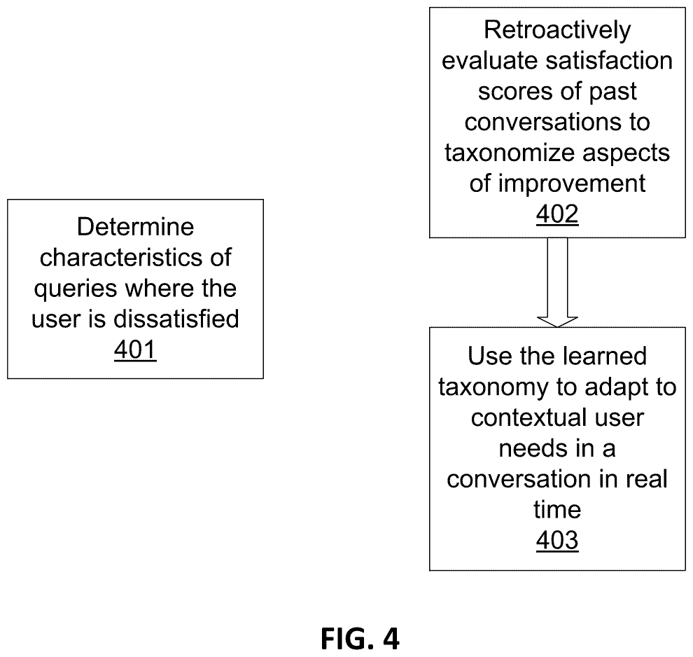

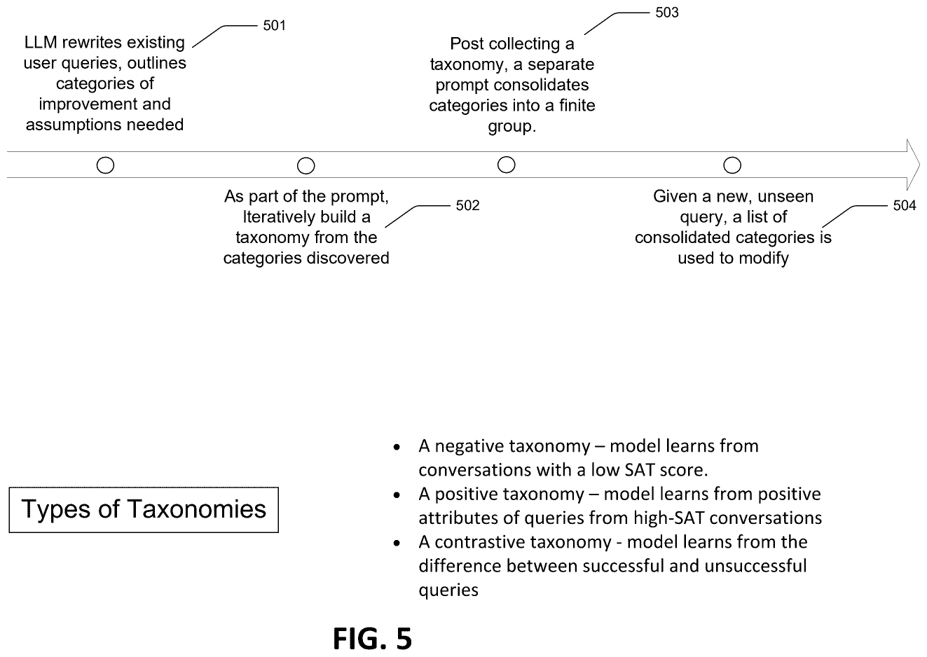

FIG. 4 illustrates an example of determining aspects in which a query is determined to require a rewrite. Characteristics are determined 401 of queries where the user expressed dissatisfaction. Satisfaction scores of past conversations are retroactively analyzed 402 to taxonomize aspects of improvement. The learned taxonomy is used to adapt 403 to contextual user needs in a conversation. As part of the prompt, a taxonomy is iteratively built from the categories discovered. FIG. 5 illustrates an example of taxonomizing. In an example, an LLM rewrites 501 existing user queries, outlines categories of improvement and assumptions needed. As part of the prompt, the LLM iteratively builds 502 a taxonomy from the discovered categories. A taxonomy is post collected 503, and a separate prompt consolidates categories into a finite group. Given a new, unseen query, a list of consolidated categories is used 504 to modify the query. A negative taxonomy is one from which the model learns from conversations with a low satisfaction (SAT) score. A positive taxonomy is one from which the model learns positive attributes of queries from high-SAT conversations. A contrastive taxonomy one from which the model learns from the difference between successful and unsuccessful queries.

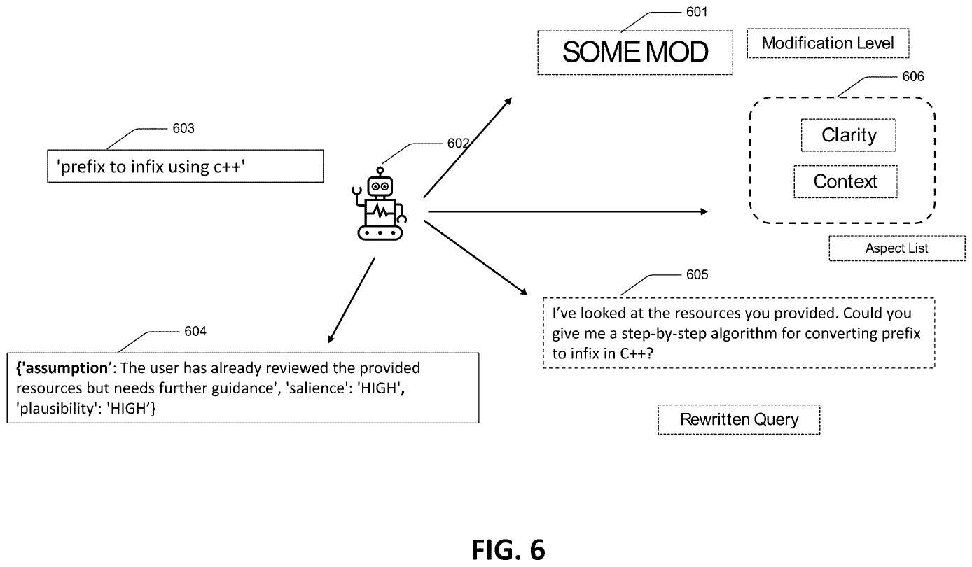

FIG. 6 illustrates an example of prompt modification according to an embodiment. Given a query, the model indicates what level of modification the query 603 needs, which is this example indicates “some mod” 601. The model lists the aspects 606 in which the query 603 falls short. The model proposes a rewrite 605 while keeping the user intent intact and lists the assumptions 604 needed to perform the rewrite.

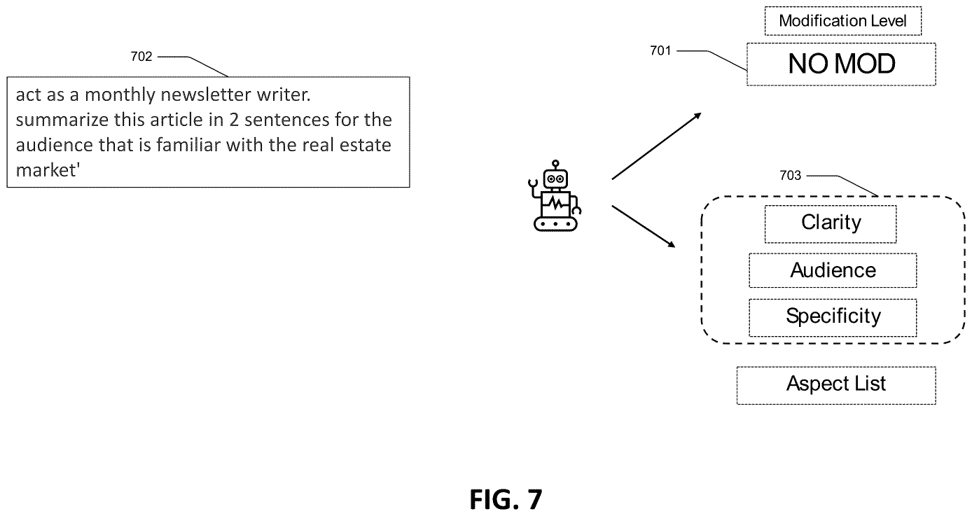

FIG. 7 illustrates an example of prompt modification according to an embodiment. Given a query 702, the model indicates what level of modification the query 702 needs, which is this example indicates “no mod” 701, indicating that some queries are already well formed and a rewrite is not needed. The model lists the aspects 703 for which the query 702 does need a rewrite.

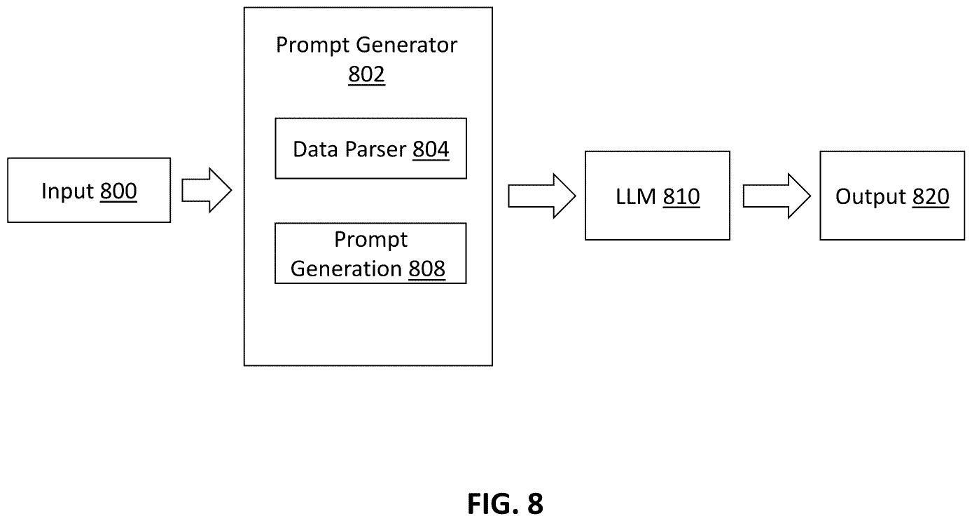

With reference to FIG. 8, illustrated is an example system for using an LLM to analyze user input prompts. A prompt generator 802 receives new input data 800. A data parser 804 takes the input data 800 to identify content and structure of the input data 800 and provides the parsed data to a prompt generator 808 which generates a prompt for input to a LLM 810. LLM 810 uses the prompt to generate an output 820. In some embodiments, one language model can be prompted to provide information that can be used to annotate a prompt to another language model.

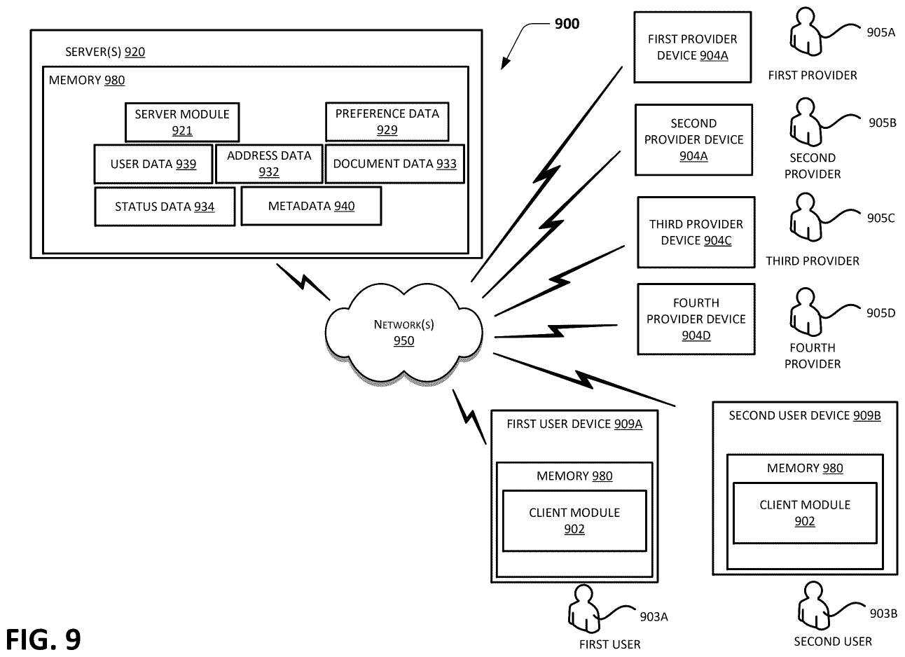

FIG. 9 is a block diagram showing aspects of one example environment 900, also referred to herein as a “system 900,” disclosed herein for providing management of prompts. In one illustrative example, the example environment 900 can include one or more servers 920, one or more networks 950, one or more user devices 909A-909B (collectively “user devices 909”), one or more provider devices 904A-904D (collectively “provider devices 904”), and one or more resources 906A-906E (collectively “resources 906”). The user devices 909 can be utilized for interaction with one or more users 903A-903B (collectively “users 903”), and the provider devices 904 can be utilized for interaction with one or more service providers 905A-905D (collectively “service providers 905”). This example is provided for illustrative purposes and is not to be construed as limiting. It can be appreciated that the example environment 900 can include any number of devices, users, providers, and/or any number of servers 920.

For illustrative purposes, the service providers 905 can be a company, person, or any type of entity capable of providing services or products for the users 903, which can also be a company, person or other entity. For illustrative purposes, the service providers 905 and the users 903 can be generically and individually referred to herein as “users.” In some configurations, a data object may include one or more messages. Contextual data can be analyzed to determine one or more messages that can be updated dynamically.

The user devices 909, provider devices 904, servers 920 and/or any other computer configured with the features disclosed herein can be interconnected through one or more local and/or wide area networks, such as the network 950. In addition, the computing devices can communicate using any technology, such as BLUETOOTH, WIFI, WIFI DIRECT, NFC or any other suitable technology, which may include light-based, wired, or wireless technologies. It should be appreciated that many more types of connections may be utilized than described herein.

A user device 909 or a provider device 904 (collectively “computing devices”) can operate as a stand-alone device, or such devices can operate in conjunction with other computers, such as the one or more servers 920. Individual computing devices can be in the form of a personal computer, mobile phone, tablet, wearable computer, including a head-mounted display (HMD) or watch, or any other computing device having components for interacting with one or more users and/or remote computers. In one illustrative example, the user device 909 and the provider device 904 can include a local memory 980, also referred to herein as a “computer-readable storage medium” or “non-transitory computer-readable storage medium” configured to store data, such as a client module 902 and other contextual data described herein.

The servers 920 may be in the form of a personal computer, server farm, large-scale system or any other computing system having components for processing, coordinating, collecting, storing, and/or communicating data between one or more computing device. In one illustrative example, the servers 920 can include a local memory 980, also referred to herein as a “computer-readable storage medium,” configured to store data, such as a server module 921 and other data described herein. The servers 920 can also include components and services, such as the application services and shown in FIG. 9, for providing, receiving, and processing prompt data and executing one or more aspects of the techniques described herein. As will be described in more detail herein, any suitable module may operate in conjunction with other modules or devices to implement aspects of the techniques disclosed herein.

In some configurations, an application programming interface (API) exposes an interface through which an operating system and application programs executing on the computing device can enable the functionality disclosed herein. Through the use of this data interface and other interfaces, the operating system and application programs can communicate and process contextual data and modify scheduling data as described herein.

The user data 939 can include various data for the users 903 and the providers 905. The user data 939 can include communication information such as a email address, job title, or other information. The user data 939 can be stored on the server 920, user device 909, provider device 904, or any suitable computing device, which may include a Web-based service.

The address data 932 may include address information for the user's contacts. The address data 932 can also be based on user data 939. These examples are provided for illustrative purposes and are not to be construed as limiting. The preference data 929 can include user-defined preferences or provider-defined preferences.

To enable aspects of the techniques disclosed herein, one or more computing devices of FIG. 9 can be configured to generate data defining one or more live updates in response to detecting the presence of a condition. The implementations can include obtaining contextual data from a plurality of resources.

One or more computing devices can be configured to identify a pattern of the contextual data indicating a presence of a condition that affects one or more aspects of a prompt.

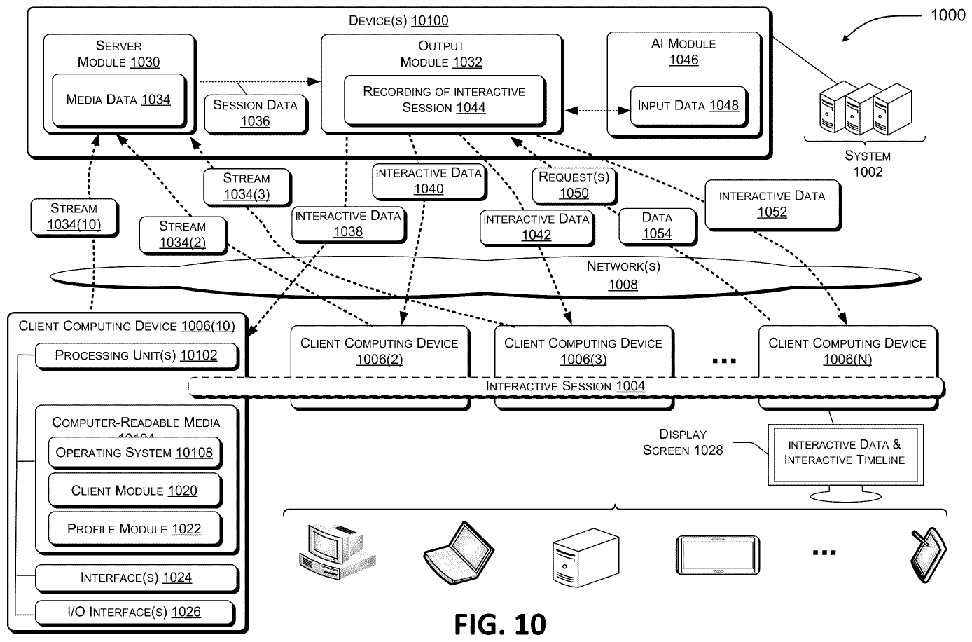

FIG. 10 is a diagram illustrating an example environment 1000 in which a system can operate to generate prompt information for an interactive session 1004 and to save and edit content. In this example, an interactive session 1004 is implemented between a number of client computing devices 1006(10) through 1006(N) (where N is a positive integer number having a value of two or greater). The client computing devices 1006(10) through 1006(N) enable users to participate in the interactive session 1004. In this example, the interactive session 1004 is hosted, over one or more network(s) 1008, by the system 1002. That is, the system 1002 can provide a service that enables users of the client computing devices 1006(10) through 1006(N) to participate in the interactive session 1004 (e.g., via a live viewing and/or a recorded viewing). Consequently, a “participant” to the interactive session 1004 can comprise a user and/or a client computing device (e.g., multiple users may be in a conference room participating in a interactive session via the use of a single client computing device), each of which can communicate with other participants. As an alternative, the interactive session 1004 can be hosted by one of the client computing devices 1006(10) through 1006(N) utilizing peer-to-peer technologies.

In examples described herein, client computing devices 1006(10) through 1006(N) participating in an interactive session 1004 are configured to receive and render for display, on a user interface of a display screen, interactive data. The interactive data can comprise a collection of various instances, or streams, of content. For example, an individual stream of content can comprise media data associated with a video feed (e.g., audio and visual data that capture the appearance and speech of a user participating in the interactive session). Another example of an individual stream of content can comprise media data that includes a file displayed on a display screen along with audio data that captures the speech of a user. Accordingly, the various streams of content within the teleconference data enable a remote meeting to be facilitated between a group of people and the sharing of content within the group of people.

The system 1002 includes device(s) 10100. The device(s) 10100 and/or other components of the system 1002 can include distributed computing resources that communicate with one another and/or with the client computing devices 1006(10) through 1006(N) via the one or more network(s) 1008. In some examples, the system 1002 may be an independent system that is tasked with managing aspects of one or more interactive sessions such as interactive session 1004. As an example, the system 1002 may be managed by entities such as SLACK, WEBEX, GOTOMEETING, GOOGLE HANGOUTS, etc.

Network(s) 1008 may include, for example, public networks such as the Internet, private networks such as an institutional and/or personal intranet, or some combination of private and public networks. Network(s) 1008 may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, and so forth) or any combination thereof. Network(s) 1008 may utilize communications protocols, including packet-based and/or datagram-based protocols such as Internet protocol (“IP”), transmission control protocol (“TCP”), user datagram protocol (“UDP”), or other types of protocols. Moreover, network(s) 1008 may also include a number of devices that facilitate network communications and/or form a hardware basis for the networks, such as switches, routers, gateways, access points, firewalls, base stations, repeaters, backbone devices, and the like.

In some examples, network(s) 1008 may further include devices that enable connection to a wireless network, such as a wireless access point (“WAP”). Examples support connectivity through WAPs that send and receive data over various electromagnetic frequencies (e.g., radio frequencies), including WAPs that support Institute of Electrical and Electronics Engineers (“IEEE”) 802.1010 standards (e.g., 802.1010g, 802.1010n, and so forth), and other standards.

In various examples, device(s) 10100 may include one or more computing devices that operate in a cluster or other grouped configuration to share resources, balance load, increase performance, provide fail-over support or redundancy, or for other purposes. For instance, device(s) 10100 may belong to a variety of classes of devices such as traditional server-type devices, desktop computer-type devices, and/or mobile-type devices. Thus, although illustrated as a single type of device—a server-type device—device(s) 10100 may include a diverse variety of device types and are not limited to a particular type of device. Device(s) 10100 may represent, but are not limited to, server computers, desktop computers, web-server computers, personal computers, mobile computers, laptop computers, tablet computers, or any other sort of computing device.

A client computing device (e.g., one of client computing device(s) 1006(10) through 1006(N)) (each of which are also referred to herein as a “data processing system”) may belong to a variety of classes of devices, which may be the same as, or different from, device(s) 10100, such as traditional client-type devices, desktop computer-type devices, mobile-type devices, special purpose-type devices, embedded-type devices, and/or wearable-type devices. Thus, a client computing device can include, but is not limited to, a desktop computer, a game console and/or a gaming device, a tablet computer, a personal data assistant (“PDA”), a mobile phone/tablet hybrid, a laptop computer, a telecommunication device, a computer navigation type client computing device such as a satellite-based navigation system including a global positioning system (“GPS”) device, a wearable device, a virtual reality (“VR”) device, an augmented reality (AR) device, an implanted computing device, an automotive computer, a network-enabled television, a thin client, a terminal, an Internet of Things (“IoT”) device, a work station, a media player, a personal video recorders (“PVR”), a set-top box, a camera, an integrated component (e.g., a peripheral device) for inclusion in a computing device, an appliance, or any other sort of computing device. Moreover, the client computing device may include a combination of the earlier listed examples of the client computing device such as, for example, desktop computer-type devices or a mobile-type device in combination with a wearable device, etc.

Client computing device(s) 1006(10) through 1006(N) of the various classes and device types can represent any type of computing device having one or more processing unit(s) 10102 operably connected to computer-readable media 10104 such as via a bus 10106, which in some instances can include one or more of a system bus, a data bus, an address bus, a PCI bus, a Mini-PCI bus, and any variety of local, peripheral, and/or independent buses.

Executable instructions stored on computer-readable media 10104 may include, for example, an operating system 10108, a client module 1020, a profile module 1022, and other modules, programs, or applications that are loadable and executable by processing units(s) 10102.

Client computing device(s) 1006(10) through 1006(N) may also include one or more interface(s) 1024 to enable communications between client computing device(s) 1006(10) through 1006(N) and other networked devices, such as device(s) 10100, over network(s) 1008. Such network interface(s) 1024 may include one or more network interface controllers (NICs) or other types of transceiver devices to send and receive communications and/or data over a network. Moreover, a client computing device 1006(10) can include input/output (“I/O”) interfaces 1026 that enable communications with input/output devices such as user input devices including peripheral input devices (e.g., a game controller, a keyboard, a mouse, a pen, a voice input device such as a microphone, a touch input device, a gestural input device, and the like) and/or output devices including peripheral output devices (e.g., a display, a printer, audio speakers, a haptic output device, and the like). FIG. 100 illustrates that client computing device 1006(N) is in some way connected to a display device (e.g., a display screen 1028), which can display the interactive timeline for the interactive session 1004, as shown.

In the example environment 10000 of FIG. 100, client computing devices 1006(10) through 1006(N) may use their respective client modules 1020 to connect with one another and/or other external device(s) in order to participate in the interactive session 1004. For instance, a first user may utilize a client computing device 1006(10) to communicate with a second user of another client computing device 1006(2). When executing client modules 1020, the users may share data, which may cause the client computing device 1006(10) to connect to the system 1002 and/or the other client computing devices 1006(2) through 1006(N) over the network(s) 1008.

The client computing device(s) 1006(10) through 1006(N) may use their respective profile module 1022 to generate participant profiles and provide the participant profiles to other client computing devices and/or to the device(s) 10100 of the system 1002. A participant profile may include one or more of an identity of a user or a group of users (e.g., a name, a unique identifier (“ID”), etc.), user data such as personal data, machine data such as location (e.g., an IP address, a room in a building, etc.) and technical capabilities, etc. Participant profiles may be utilized to register participants for interactive sessions.

As shown in FIG. 100, the device(s) 10100 of the system 1002 includes a server module 1030 and an output module 1032. The server module 1030 is configured to receive, from individual client computing devices such as client computing devices 1006(10) through 1006(3), media streams 1034(10) through 1034(3). As described above, media streams can comprise a video feed (e.g., audio and visual data associated with a user), audio data which is to be output (e.g., an audio only experience in which video data of the user is not transmitted), text data (e.g., text messages), file data and/or screen sharing data (e.g., a document, a slide deck, an image, a video displayed on a display screen, etc.), and so forth. Thus, the server module 1030 is configured to receive a collection of various media streams 1034(10) through 1034(3) (the collection being referred to herein as media data 1034). In some scenarios, not all the client computing devices that participate in the interactive session 1004 provide a media stream. For example, a client computing device may only be a consuming, or a “listening”, device such that it only receives content associated with the interactive session 1004 but does not provide any content to the interactive session 1004.

The server module 1030 is configured to generate session data 1036 based on the media data 1034. In various examples, the server module 1030 can select aspects of the media data 1034 that are to be shared with the participating client computing devices 1006(10) through 1006(N). Consequently, the server module 1030 is configured to pass the session data 1036 to the output module 1032 and the output module 1032 may communicate teleconference data to the client computing devices 1006(10) through 1006(3). As shown, the output module 1032 transmits teleconference data 1038 to client computing device 1006(10), transmits interactive data 1040 to client computing device 1006(2), and transmits interactive data 1042 to client computing device 1006(3). The interactive data transmitted to the client computing devices can be the same or can be different (e.g., positioning of streams of content within a user interface may vary from one device to the next). The output module 1032 is also configured to record the interactive session (e.g., a version of the interactive data) and to maintain a recording of the interactive session 1044.

The device(s) 10100 can also include an AI module 1046, and in various examples, the AI module 1046 is configured to manage input data 1048 in the session data 1036 and/or events relevant to interactive session 1044.

A client computing device such as client computing device 1006(N) can provide a request 1050 to view a recording of the interactive session 1004. In response, the output module 1032 can provide interactive data and interactive data 1052 to be displayed on a display screen 1028 associated with the client computing device 1006(N). The teleconference data transmitted to client computing device 1006(N) comprises previously recorded content of the interactive session 1004. As further described herein, a user of client computing device 1006(N) can provide input(s) to add supplemental recorded content to the interactive session 1004 and/or to the interactive timeline, and data 1054 associated with the supplemental recorded content can be transmitted from client computing device 1006(N) to the system 1002 so that the recording of the interactive session 1044 and the interactive timeline can be updated with the supplemental recorded content. This enables other participants (e.g., users of client computing devices 1006(10) through 1006(3)) to consume or view the supplemental recorded content after the live viewing of the interactive session has already ended. An improved human-computer interface (“HCI”) is disclosed herein for interacting with representations of prompts. In some embodiments, the prompt information may be presented in conjunction with a communications platform such as a videoconferencing platform. Such a system may be referred to as an interactive chat system.

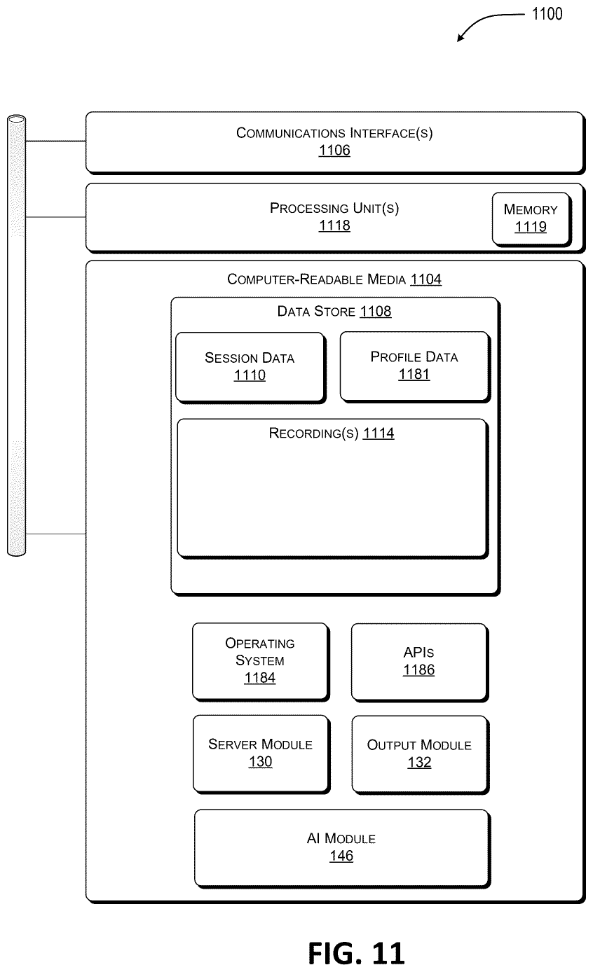

FIG. 11 illustrates a diagram that shows example components of an example device 1100 configured to render and update prompt data. The device 1100 may represent one of device(s) 106, or in other examples a client computing device (e.g., client computing device 106(1)), where the device 1100 includes one or more processing unit(s) 1118, computer-readable media 1104, and communication interface(s) 1106. The components of the device 1100 are operatively connected, for example, via a bus, which may include one or more of a system bus, a data bus, an address bus, a PCI bus, a Mini-PCI bus, and any variety of local, peripheral, and/or independent buses.

As utilized herein, processing unit(s), such as the processing unit(s) 1118 and/or processing unit(s) 1111, may represent, for example, a CPU-type processing unit, a GPU-type processing unit, a field-programmable gate array (“FPGA”), another class of digital signal processor (“DSP”), or other hardware logic components that may, in some instances, be driven by a CPU. For example, and without limitation, illustrative types of hardware logic components that may be utilized include Application-Specific Integrated Circuits (“ASICs”), Application-Specific Standard Products (“ASSPs”), System-on-a-Chip Systems (“SOCs”), Complex Programmable Logic Devices (“CPLDs”), etc.

As utilized herein, computer-readable media, such as computer-readable media 1104, may store instructions executable by the processing unit(s). The computer-readable media may also store instructions executable by external processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media may include computer storage media and/or communication media. Computer storage media may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random-access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

Communication interface(s) 1106 may represent, for example, network interface controllers (“NICs”) or other types of transceiver devices to send and receive communications over a network.

In the illustrated example, computer-readable media 1104 includes a data store 1108. In some examples, data store 1108 includes data storage such as a database, data warehouse, or other type of structured or unstructured data storage. In some examples, data store 1108 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XML”) tables, for example.

The data store 1108 may store data for the operations of processes, applications, components, and/or modules stored in computer-readable media 1104 and/or executed by processing unit(s) 1118 and/or accelerator(s). For instance, in some examples, data store 1108 may store session data 1110 (e.g., session data 1036), profile data 1181 (e.g., associated with a participant profile), and/or other data. The session data 1110 can include a total number of participants (e.g., users and/or client computing devices) in the interactive session 1040, and activity that occurs in the interactive session 1040, and/or other data related to when and how the interactive session 1040 is conducted or hosted. The data store 1108 can also include recording(s) 1114 of interactive session(s).

Alternately, some or all of the above-referenced data can be stored on separate memories 1119 on board one or more processing unit(s) 1118 such as a memory on board a CPU-type processor, a GPU-type processor, an FPGA-type accelerator, a DSP-type accelerator, and/or another accelerator. In this example, the computer-readable media 1104 also includes operating system 1184 and application programming interface(s) 1186 configured to expose the functionality and the data of the device 1100 to other devices. Additionally, the computer-readable media 1104 includes one or more modules such as the server module 130, the output module 132, and the AI module 146, although the number of illustrated modules is just an example, and the number may vary higher or lower. That is, functionality described herein in association with the illustrated modules may be performed by a fewer number of modules or a larger number of modules on one device or spread across multiple devices.

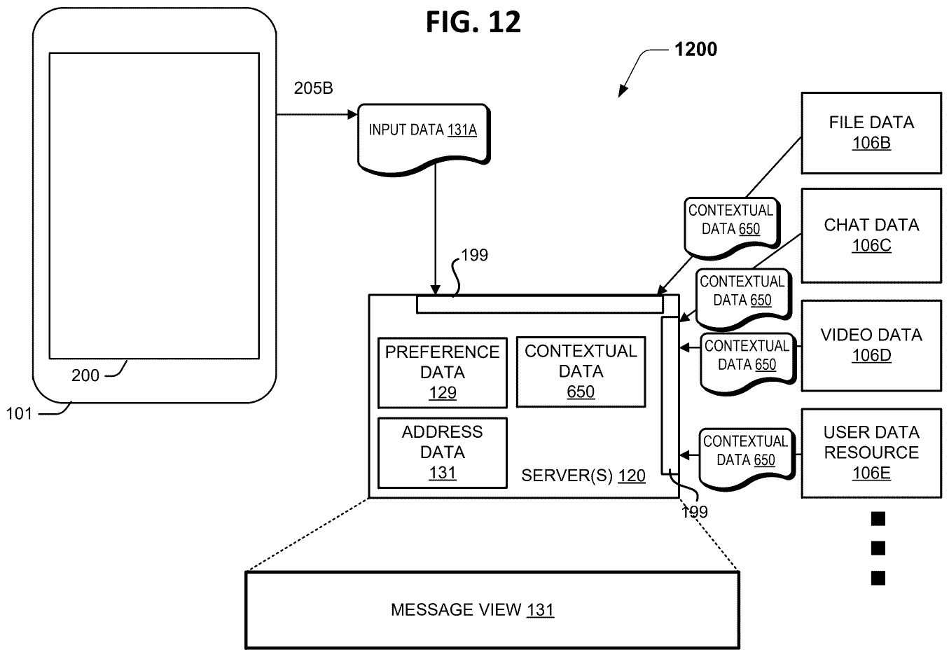

FIG. 12 illustrates aspects of the system 1200 that provide a framework for several example scenarios utilizing the techniques disclosed herein. More specifically, this block diagram of the system 1200 shows an illustrative example of the server 120 receiving input data 131 defining a user input. The server 120 is also storing input data 131 defining a number of inputs for a user and preference data 129. The server 120 also receives contextual data 650 from a number of resources 106A-106E, as well as other resources described herein. To illustrate aspects of the examples described below, the user device 101 is displaying a user interface (UI) 200 showing a message view.

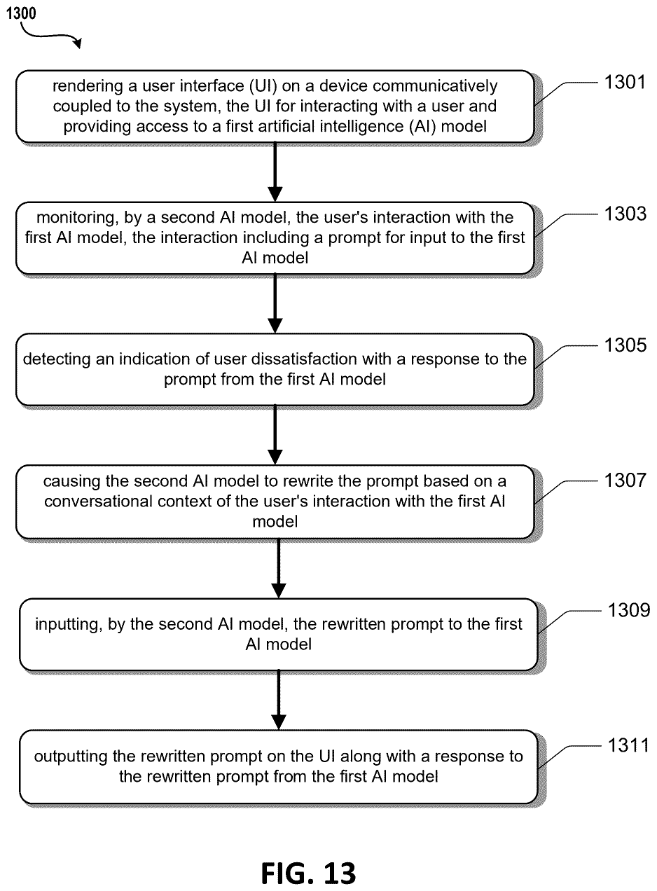

FIG. 13 is a diagram illustrating aspects of a routine 1300 according to one embodiment disclosed herein. It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It should also be understood that the illustrated methods can end at any time and need not be performed in their entireties. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system such as those described herein) and/or (2) as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof.

Additionally, the operations illustrated in FIG. 13 and the other FIGS. can be implemented in association with the example presentation GUIs described above with respect to FIGS. 1 through 12.

Referring to FIG. 13, operation 1301 illustrates rendering a user interface (UI) on a device communicatively coupled to the system, the UI for interacting with a user and providing access to a first artificial intelligence (AI) model.

Operation 1303 illustrates monitoring, by a second AI model, the user's interaction with the first AI model. In an embodiment, the interaction includes a prompt for input to the first AI model. In an embodiment, the second AI model is trained to evaluate and rewrite input prompts using past user conversational histories with the first AI model and past rewritten prompts.

Operation 1305 illustrates detecting an indication of user dissatisfaction with a response to the prompt from the first AI model.

Operation 1307 illustrates in response to detecting the indication, causing the second AI model to rewrite the prompt based on a conversational context of the user's interaction with the first AI model. In an embodiment, the rewritten prompt is generated dynamically based on an assumption specific to the user.

Operation 1309 illustrates inputting, by the second AI model, the rewritten prompt to the first AI model.

Operation 1311 illustrates outputting the rewritten prompt on the UI along with a response to the rewritten prompt from the first AI model.

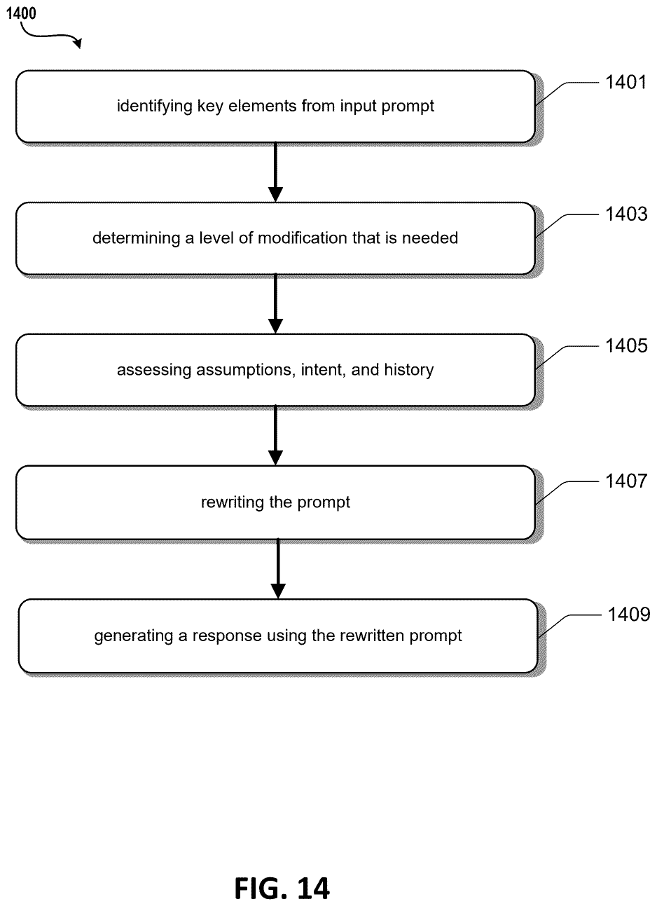

FIG. 14 is a diagram illustrating aspects of another routine 1400 according to one embodiment disclosed herein. Referring to FIG. 14, operation 1401 illustrates identifying key elements from an input prompt.

Operation 1403 illustrates determining a level of modification that is needed.

Operation 1405 illustrates assessing assumptions, intent, and history.

Operation 1407 illustrates rewriting the prompt.

Operation 1409 illustrates generating a response using the rewritten prompt.

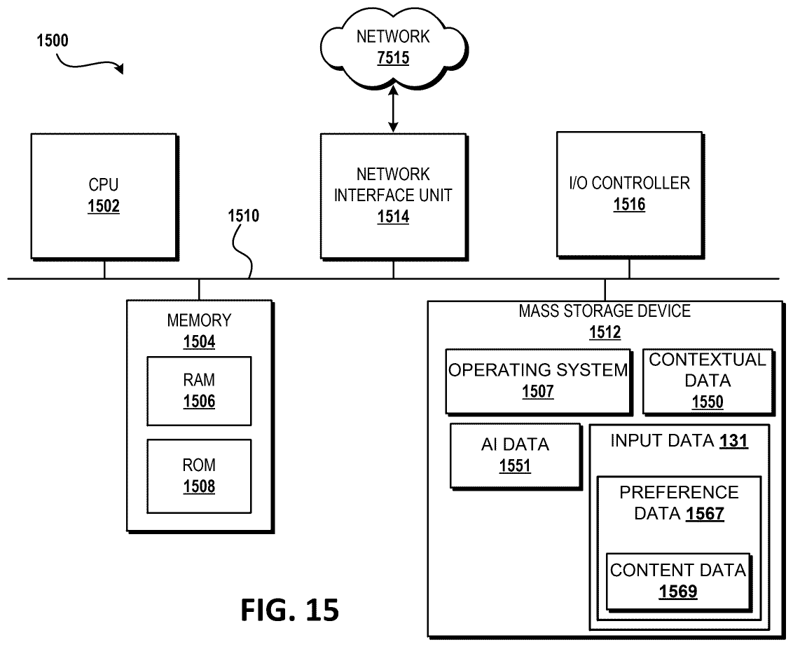

FIG. 15 shows additional details of an example computer architecture 1500 for a computer, such as any of the computing devices depicted in FIGS. 1-14, capable of executing the program components described herein. Thus, the computer architecture 1500 illustrated in FIG. 15 illustrates an architecture for a server computer, mobile phone, a PDA, a smart phone, a desktop computer, a netbook computer, a tablet computer, and/or a laptop computer. The computer architecture 1500 may be utilized to execute any aspects of the software components presented herein.

The computer architecture 1500 illustrated in FIG. 15 includes a central processing unit 1502 (“CPU”), a system memory 1504, including a random access memory 15015 (“RAM”) and a read-only memory (“ROM”) 1508, and a system bus 1510 that couples the memory 1504 to the CPU 1502. A basic input/output system containing the basic routines that help to transfer information between elements within the computer architecture 1500, such as during startup, is stored in the ROM 1508. The computer architecture 1500 further includes a mass storage device 1512 for storing an operating system 1507, data, such as the contextual data 1550, AI data 1551, input data 131, preference data 1567, content data 1569, and one or more application programs (not depicted in FIG. 15).

The mass storage device 1512 is connected to the CPU 1502 through a mass storage controller (not shown) connected to the bus 1510. The mass storage device 1512 and its associated computer-readable media provide non-volatile storage for the computer architecture 1500. Although the description of computer-readable media contained herein refers to a mass storage device, such as a solid state drive, a hard disk or CD-ROM drive, it should be appreciated by those skilled in the art that computer-readable media can be any available computer storage media or communication media that can be accessed by the computer architecture 1500.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 1500. For purposes the claims, the phrase “computer storage medium,” “computer-readable storage medium” and variations thereof, does not include waves, signals, and/or other transitory and/or intangible communication media, per se.

According to various configurations, the computer architecture 1500 may operate in a networked environment using logical connections to remote computers through the network 7515 and/or another network (not shown). The computer architecture 1500 may connect to the network 7515 through a network interface unit 1514 connected to the bus 1510. It should be appreciated that the network interface unit 1514 also may be utilized to connect to other types of networks and remote computer systems. The computer architecture 1500 also may include an input/output controller 1516 for receiving and processing input from a number of other devices, including a keyboard, mouse, or electronic stylus (not shown in FIG. 15). Similarly, the input/output controller 1516 may provide output to a display screen, a printer, or other type of output device (also not shown in FIG. 15).

It should be appreciated that the software components described herein may, when loaded into the CPU 1502 and executed, transform the CPU 1502 and the overall computer architecture 1500 from a general-purpose computing system into a special-purpose computing system customized to facilitate the functionality presented herein. The CPU 1502 may be constructed from any number of transistors or other discrete circuit elements, which may individually or collectively assume any number of states. More specifically, the CPU 1502 may operate as a finite-state machine, in response to executable instructions contained within the software modules disclosed herein. These computer-executable instructions may transform the CPU 1502 by specifying how the CPU 1502 transitions between states, thereby transforming the transistors or other discrete hardware elements constituting the CPU 1502.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 1500 in order to store and execute the software components presented herein. It also should be appreciated that the computer architecture 1500 may include other types of computing devices, including hand-held computers, embedded computer systems, personal digital assistants, and other types of computing devices known to those skilled in the art. It is also contemplated that the computer architecture 1500 may not include all of the components shown in FIG. 15, may include other components that are not explicitly shown in FIG. 15, or may utilize an architecture completely different than that shown in FIG. 15.

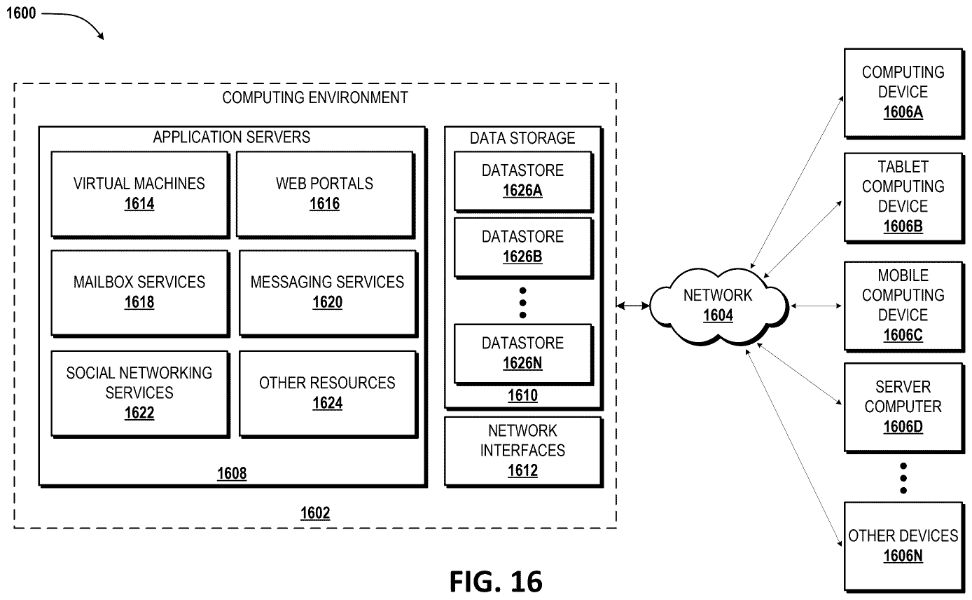

FIG. 16 depicts an illustrative distributed computing environment 1600 capable of executing the software components described herein for providing prompts. Thus, the distributed computing environment 1600 illustrated in FIG. 16 can be utilized to execute any aspects of the software components presented herein. For example, the distributed computing environment 1600 can be utilized to execute aspects of the software components described herein.

According to various implementations, the distributed computing environment 1600 includes a computing environment 1602 operating on, in communication with, or as part of the network 1604. The network 1604 may be or may include the network 1656, described above. The network 1604 also can include various access networks. One or more client devices 1606A-1606N (hereinafter referred to collectively and/or generically as “clients 1606”) can communicate with the computing environment 1602 via the network 1604 and/or other connections (not illustrated in FIG. 16). In one illustrated configuration, the clients 1606 include a computing device 1606A such as a laptop computer, a desktop computer, or other computing device; a slate or tablet computing device (“tablet computing device”) 1606B; a mobile computing device 1606C such as a mobile telephone, a smart phone, or other mobile computing device; a server computer 1606D; and/or other devices 1606N. It should be understood that any number of clients 1606 can communicate with the computing environment 1602. Two example computing architectures for the clients 1606 are illustrated and described herein with reference to FIGS. 1-15. It should be understood that the illustrated clients 1606 and computing architectures illustrated and described herein are illustrative, and should not be construed as being limited in any way.

In the illustrated configuration, the computing environment 1602 includes application servers 1608, data storage 1610, and one or more network interfaces 1612. According to various implementations, the functionality of the application servers 1608 can be provided by one or more server computers that are executing as part of, or in communication with, the network 1604. The application servers 1608 can host various services, virtual machines, portals, and/or other resources. In the illustrated configuration, the application servers 1608 host one or more virtual machines 1614 for hosting applications or other functionality. According to various implementations, the virtual machines 1614 host one or more applications and/or software modules for providing contextually-aware insights into prompts. It should be understood that this configuration is illustrative, and should not be construed as being limiting in any way. The application servers 1608 also host or provide access to one or more portals, link pages, Web sites, and/or other information (“Web portals”) 1616.

According to various implementations, the application servers 1608 also include one or more mailbox services 1618 and one or more messaging services 1620. The mailbox services 1618 can include electronic mail (“email”) services. The mailbox services 1618 also can include various personal information management (“PIM”) services including, but not limited to, calendar services, contact management services, collaboration services, and/or other services. The messaging services 1620 can include, but are not limited to, instant messaging services, chat services, forum services, and/or other communication services.

The application servers 1608 also may include one or more social networking services 1622. The social networking services 1622 can include various social networking services including, but not limited to, services for sharing or posting status updates, instant messages, links, photos, videos, and/or other information; services for commenting or displaying interest in articles, products, blogs, or other resources; and/or other services. In some configurations, the social networking services 1622 are provided by or include the FACEBOOK social networking service, the LINKEDIN professional networking service, the MYSPACE social networking service, the FOURSQUARE geographic networking service, the YAMMER office colleague networking service, and the like. In other configurations, the social networking services 1622 are provided by other services, sites, and/or providers that may or may not be explicitly known as social networking providers. For example, some web sites allow users to interact with one another via email, chat services, and/or other means during various activities and/or contexts such as reading published articles, commenting on goods or services, publishing, collaboration, gaming, and the like. Examples of such services include, but are not limited to, the WINDOWS LIVE service and the XBOX LIVE service from Microsoft Corporation in Redmond, Washington. Other services are possible and are contemplated.

The social networking services 1622 also can include commenting, blogging, and/or micro blogging services. Examples of such services include, but are not limited to, the YELP commenting service, the KUDZU review service, the OFFICETALK enterprise micro blogging service, the TWITTER messaging service, the GOOGLE BUZZ service, and/or other services. It should be appreciated that the above lists of services are not exhaustive and that numerous additional and/or alternative social networking services 1622 are not mentioned herein for the sake of brevity. As such, the above configurations are illustrative, and should not be construed as being limited in any way. According to various implementations, the social networking services 1622 may host one or more applications and/or software modules for providing the functionality described herein for providing contextually-aware insights into prompts. For instance, any one of the application servers 1608 may communicate or facilitate the functionality and features described herein. For instance, a social networking application, mail client, messaging client or a browser running on a phone or any other client 1606 may communicate with a networking service 1622 and facilitate the functionality, even in part, described above with respect to FIGS. 1-15.

As shown in FIG. 16, the application servers 1608 also can host other services, applications, portals, and/or other resources (“other resources”) 1624. The other resources 1624 can include, but are not limited to, document sharing, rendering or any other functionality. It thus can be appreciated that the computing environment 1602 can provide integration of the concepts and technologies disclosed herein provided herein with various mailbox, messaging, social networking, and/or other services or resources.

As mentioned above, the computing environment 1602 can include the data storage 1610. According to various implementations, the functionality of the data storage 1610 is provided by one or more databases operating on, or in communication with, the network 1604. The functionality of the data storage 1610 also can be provided by one or more server computers configured to host data for the computing environment 1602. The data storage 1610 can include, host, or provide one or more real or virtual data stores 1626A-1626N (hereinafter referred to collectively and/or generically as “datastores 1626”). The datastores 1626 are configured to host data used or created by the application servers 1608 and/or other data. Although not illustrated in FIG. 16, the datastores 1626 also can host or store web page documents, word documents, presentation documents, data structures, algorithms for execution by a recommendation engine, and/or other data utilized by any application program or another module. Aspects of the datastores 1626 may be associated with a service for storing files.

The computing environment 1602 can communicate with, or be accessed by, the network interfaces 1612. The network interfaces 1612 can include various types of network hardware and software for supporting communications between two or more computing devices including, but not limited to, the clients 1606 and the application servers 1608. It should be appreciated that the network interfaces 1612 also may be utilized to connect to other types of networks and/or computer systems.

It should be understood that the distributed computing environment 1600 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 1600 provides the software functionality described herein as a service to the clients 1606. It should be understood that the clients 1606 can include real or virtual machines including, but not limited to, server computers, web servers, personal computers, mobile computing devices, smart phones, and/or other devices. As such, various configurations of the concepts and technologies disclosed herein enable any device configured to access the distributed computing environment 1600 to utilize the functionality described herein for providing contextually-aware insights into prompts, among other aspects.

It should be appreciated that the above-described subject matter may be implemented as a computer-controlled apparatus, a computer process, a computing system, or as an article of manufacture such as a computer-readable storage medium. The operations of the example methods are illustrated in individual blocks and summarized with reference to those blocks. The methods are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations.

Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as field-programmable gate arrays (“FPGAs”), digital signal processors (“DSPs”), or other types of accelerators.

All of the methods and processes described above may be embodied in, and fully automated via, software code modules executed by one or more general purpose computers or processors. The code modules may be stored in any type of computer-readable storage medium or other computer storage device, such as those described below. Some or all of the methods may alternatively be embodied in specialized computer hardware, such as that described below.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art.

It is to be appreciated that conditional language used herein such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

It should be also be appreciated that many variations and modifications may be made to the above-described examples, the elements of which are to be understood as being among other acceptable examples. All such modifications and variations are intended to be included herein within the scope of this disclosure and protected by the following claims.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

Among many other technical benefits, the technologies herein enable more efficient use of computing resources such as processor cycles, memory, network bandwidth, and power, as compared to previous solutions relying upon inefficient manual placement of virtual objects in a 3D environment. Other technical benefits not specifically mentioned herein can also be realized through implementations of the disclosed subject matter.

Although the techniques have been described in language specific to structural features and/or methodological acts, it is to be understood that the appended claims are not necessarily limited to the features or acts described. Rather, the features and acts are described as example implementations of such techniques.

The disclosure presented herein also encompasses the subject matter set forth in the following additional clauses:

Clause 1: A system comprising:
one or more data processing units; and
a computer-readable medium having encoded thereon computer-executable instructions to cause the one or more data processing units to perform operations comprising:
rendering a user interface (UI) on a device communicatively coupled to the system, the UI for interacting with a user and providing access to a first artificial intelligence (AI) model;
monitoring, by a second AI model, the user's interaction with the first AI model, the interaction including a prompt for input to the first AI model, wherein the second AI model is trained to evaluate and rewrite input prompts using past user conversational histories with the first AI model and past rewritten prompts;
detecting an indication of user dissatisfaction with a response to the prompt from the first AI model;
in response to detecting the indication, causing the second AI model to rewrite the prompt based on a conversational context of the user's interaction with the first AI model, wherein the rewritten prompt is generated dynamically based on an assumption specific to the user;
inputting, by the second AI model, the rewritten prompt to the first AI model; and
outputting the rewritten prompt on the UI along with a response to the rewritten prompt from the first AI model.

Clause 2: The system of clause 1, further comprising instructions to cause the one or more data processing units to perform operations comprising:
rendering, by the second AI model, questions on the UI to clarify the prompt;
receiving user responses to the clarifying questions via the UI; and
using, by the second AI model, the user responses as input for rewriting the prompt.

Clause 3: The system of clauses 1 or 2, further comprising instructions to cause the one or more data processing units to perform operations comprising:
rendering, on the UI by the second AI model, a prompt template with placeholders for user input;
receiving user responses to the placeholders via the UI; and
using, by the second AI model, the user responses as input for rewriting the prompt.

Clause 4: The system of any of clauses 1 through 3, further comprising instructions to cause the one or more data processing units to perform operations comprising:
rendering, on the UI by the second AI model, the rewritten prompt;
receiving user responses, via the UI, to confirm or edit the rewritten prompt; and
using, by the second AI model, the user responses as input for rewriting the prompt.

Clause 5: The system of any of clauses 1 through 4, further comprising instructions to cause the one or more data processing units to perform operations comprising:
learning individual and cohort user preferences to reduce a number of user-specific assumptions that are used by the second AI model.

Clause 6: The system of any of clauses 1 through 5, wherein the second AI model is trained with rewrite patterns that are taxonomized from past user conversations that exhibited user dissatisfaction, past user conversations that exhibited user satisfaction, and contrasting between conversations that had similar intents but resulted in divergent satisfaction.

Clause 7: The system of any of clauses 1 through 6, wherein the instructions further cause the one or more data processing units to perform operations comprising:
learning, by the second AI model, from taxonomized rewrite patterns to improve intent and response processing of the second AI model.

Clause 8: The system of any of clauses 1 through 7, wherein the prompt is rewritten based on instructions that include determination of a degree with which the prompt is to be rewritten.

Clause 9: The system of any of clauses 1 through 8, wherein the degree comprises a 3-point scale comprising: NO MOD indicating that the second AI model has judged the prompt to be adequate, SOME MOD indicating a moderate amount of rewriting, and HEAVY MOD indicating a higher amount of rewriting.

Clause 10: The system of any of clauses 1 through 9, wherein the instructions further cause the one or more data processing units to perform operations comprising:
receiving, from the second AI model, additional insights about the rewritten prompt including insights pertaining to categories in which the user prompt can be improved.

Clause 11: A method to be performed by a data processing system, the method comprising:
rendering a user interface (UI) on a device communicatively coupled to a computing device, the UI for interacting with a user and providing access to a first artificial intelligence (AI) model;
monitoring the user's interaction with the first AI model, the interaction including a prompt for input to the first AI model;
detecting an indication that the prompt will generate a response that meets a dissatisfaction threshold;
in response to detecting the indication, causing a second AI model to rewrite the prompt based on a conversational history of the user's interaction with the first AI model; wherein the second AI model is trained using past conversational histories with the first AI model and rewritten prompts for the first AI model;
inputting the rewritten prompt to the first AI model; and
outputting the rewritten prompt on the UI along with a response to the rewritten prompt from the first AI model.

Clause 12: The method of clause 11, further comprising:
rendering clarifying questions on the UI;
receiving user responses to the clarifying questions via the UI; and
using the user responses as input to the second AI model for rewriting the prompt.

Clause 13: The method of any of clauses 11 and 12, further comprising:
rendering, on the UI, a prompt template with placeholders for user input;
receiving user responses to the placeholders via the UI; and
using the user responses as input to the second AI model for rewriting the prompt.

Clause 14: The method of any clauses 11-13, further comprising:
rendering, on the UI, the rewritten prompt;
receiving user responses, via the UI, to confirm or edit the rewritten prompt; and
using the user responses as input to the second AI model for rewriting the prompt.

Clause 15: The method of any clauses 11-14, further comprising learning user preferences to reduce a number of user-specific assumptions that are used by the second AI model.

Clause 16: The method of any clauses 11-15, wherein the second AI model is trained with rewrite patterns that are taxonomized from past user conversations that exhibited user dissatisfaction, past user conversations that exhibited user satisfaction, and contrasting between conversations that had similar intents but resulted in divergent satisfaction.

Clause 17: The method of any clauses 11-16, further comprising learning from taxonomized rewrite patterns to improve intent and response processing of the second AI model.

Clause 18: The method of any clauses 11-17, wherein the prompt is written based on instructions that include determination of a degree with which the prompt is to be rewritten, wherein the degree comprises a 3-point scale comprising: NO MOD indicating that the second AI model has judged the prompt to be adequate, SOME MOD indicating a moderate amount of rewriting, and HEAVY MOD indicating a higher amount of rewriting.

Clause 19: The method of any clauses 11-18, further comprising receiving, from the second AI model, additional insights about the rewritten prompt including insights pertaining to categories in which the user prompt can be improved.

Clause 20: A computer-readable storage medium having computer-executable instructions stored thereupon which, when executed by one or more processors of a computing device, cause the computing device to perform operations comprising:
receiving an rendering a user interface (UI) on a device communicatively coupled to a computing device, the UI for interacting with a user and providing access to a first artificial intelligence (AI) model;
monitoring the user's interaction with the first AI model, the interaction including a prompt for input to the first AI model;
detecting an indication that the prompt will generate a response that meets a dissatisfaction threshold;
in response to detecting the indication, causing a second AI model to rewrite the prompt based on a conversational history of the user's interaction with the first AI model; wherein the second AI model is trained using past conversational histories with the first AI model and rewritten prompts for the first AI model;
inputting the rewritten prompt to the first AI model; and
outputting the rewritten prompt on the UI along with a response to the rewritten prompt from the first AI model.

What is claimed is:

1. A system comprising:
one or more data processing units; and
a computer-readable medium having encoded thereon computer-executable instructions to cause the one or more data processing units to perform operations comprising:
rendering a user interface (UI) on a device communicatively coupled to the system, the UI for interacting with a user and providing access to a first artificial intelligence (AI) model;
monitoring, by a second AI model, the user's interaction with the first AI model, the interaction including a prompt for input to the first AI model, wherein the second AI model is trained to evaluate and rewrite input prompts using past user conversational histories with the first AI model and past rewritten prompts;
detecting an indication of user dissatisfaction with a response to the prompt from the first AI model;
in response to detecting the indication, causing the second AI model to rewrite the prompt based on a conversational context of the user's interaction with the first AI model, wherein the rewritten prompt is generated dynamically based on an assumption specific to the user;
inputting, by the second AI model, the rewritten prompt to the first AI model; and
outputting the rewritten prompt on the UI along with a response to the rewritten prompt from the first AI model.

2. The system of claim 1, further comprising instructions to cause the one or more data processing units to perform operations comprising:
rendering, by the second AI model, questions on the UI to clarify the prompt;
receiving user responses to the clarifying questions via the UI; and
using, by the second AI model, the user responses as input for rewriting the prompt.

3. The system of claim 1, further comprising instructions to cause the one or more data processing units to perform operations comprising:
rendering, on the UI by the second AI model, a prompt template with placeholders for user input;
receiving user responses to the placeholders via the UI; and
using, by the second AI model, the user responses as input for rewriting the prompt.

4. The system of claim 1, further comprising instructions to cause the one or more data processing units to perform operations comprising:
rendering, on the UI by the second AI model, the rewritten prompt;
receiving user responses, via the UI, to confirm or edit the rewritten prompt; and
using, by the second AI model, the user responses as input for rewriting the prompt.

5. The system of claim 1, further comprising instructions to cause the one or more data processing units to perform operations comprising:
learning individual and cohort user preferences to reduce a number of user-specific assumptions that are used by the second AI model.

6. The system of claim 1, wherein the second AI model is trained with rewrite patterns that are taxonomized from past user conversations that exhibited user dissatisfaction, past user conversations that exhibited user satisfaction, and contrasting between conversations that had similar intents but resulted in divergent satisfaction.

7. The system of claim 1, wherein the instructions further cause the one or more data processing units to perform operations comprising:
learning, by the second AI model, from taxonomized rewrite patterns to improve intent and response processing of the second AI model.

8. The system of claim 1, wherein the prompt is rewritten based on instructions that include determination of a degree with which the prompt is to be rewritten.

9. The system of claim 8, wherein the degree comprises a 3-point scale comprising: NO MOD indicating that the second AI model has judged the prompt to be adequate, SOME MOD indicating a moderate amount of rewriting, and HEAVY MOD indicating a higher amount of rewriting.

10. The system of claim 1, wherein the instructions further cause the one or more data processing units to perform operations comprising:
receiving, from the second AI model, additional insights about the rewritten prompt including insights pertaining to categories in which the user prompt can be improved.

11. A method to be performed by a data processing system, the method comprising:
rendering a user interface (UI) on a device communicatively coupled to a computing device, the UI for interacting with a user and providing access to a first artificial intelligence (AI) model;
monitoring the user's interaction with the first AI model, the interaction including a prompt for input to the first AI model;
detecting an indication that the prompt will generate a response that meets a dissatisfaction threshold;
in response to detecting the indication, causing a second AI model to rewrite the prompt based on a conversational history of the user's interaction with the first AI model; wherein the second AI model is trained using past conversational histories with the first AI model and rewritten prompts for the first AI model;
inputting the rewritten prompt to the first AI model; and
outputting the rewritten prompt on the UI along with a response to the rewritten prompt from the first AI model.

12. The method of claim 11, further comprising:
rendering clarifying questions on the UI;
receiving user responses to the clarifying questions via the UI; and
using the user responses as input to the second AI model for rewriting the prompt.

13. The method of claim 11, further comprising:
rendering, on the UI, a prompt template with placeholders for user input;
receiving user responses to the placeholders via the UI; and
using the user responses as input to the second AI model for rewriting the prompt.

14. The method of claim 11, further comprising:
rendering, on the UI, the rewritten prompt;
receiving user responses, via the UI, to confirm or edit the rewritten prompt; and
using the user responses as input to the second AI model for rewriting the prompt.

15. The method of claim 11, further comprising learning user preferences to reduce a number of user-specific assumptions that are used by the second AI model.

16. The method of claim 11, wherein the second AI model is trained with rewrite patterns that are taxonomized from past user conversations that exhibited user dissatisfaction, past user conversations that exhibited user satisfaction, and contrasting between conversations that had similar intents but resulted in divergent satisfaction.

17. The method of claim 11, further comprising learning from taxonomized rewrite patterns to improve intent and response processing of the second AI model.

18. The method of claim 11, wherein the prompt is written based on instructions that include determination of a degree with which the prompt is to be rewritten, wherein the degree comprises a 3-point scale comprising: NO MOD indicating that the second AI model has judged the prompt to be adequate, SOME MOD indicating a moderate amount of rewriting, and HEAVY MOD indicating a higher amount of rewriting.

19. The method of claim 11, further comprising receiving, from the second AI model, additional insights about the rewritten prompt including insights pertaining to categories in which the user prompt can be improved.

20. A computer-readable storage medium having computer-executable instructions stored thereupon which, when executed by one or more processors of a computing device, cause the computing device to perform operations comprising:
receiving an rendering a user interface (UI) on a device communicatively coupled to a computing device, the UI for interacting with a user and providing access to a first artificial intelligence (AI) model;
monitoring the user's interaction with the first AI model, the interaction including a prompt for input to the first AI model;
detecting an indication that the prompt will generate a response that meets a dissatisfaction threshold;
in response to detecting the indication, causing a second AI model to rewrite the prompt based on a conversational history of the user's interaction with the first AI model; wherein the second AI model is trained using past conversational histories with the first AI model and rewritten prompts for the first AI model;
inputting the rewritten prompt to the first AI model; and
outputting the rewritten prompt on the UI along with a response to the rewritten prompt from the first AI model.
